(19) United States
(12) Patent Application Publication
(10) Pub. No.: US 2015/0098750 A1
(43) Pub. Date: Apr. 9, 2015

(54) HEAT ISOLATING ACTUATOR LINKAGE

(71) Applicant: BorgWarner Inc., Auburn Hills, MI (US)

(72) Inventors: Mathew King, Arden, NC (US); Eli Morgan, Asheville, NC (US); Vahidin Alajbegovic, Arden, NC (US)

(73) Assignee: BorgWarner Inc., Auburn Hills, MI (US)

(21) Appl. No.: 14/400,019

(22) PCT Filed: May 1, 2013
(86) PCT No.: PCT/US2013/038978

§ 371 Date: Nov. 10, 2014

Related U.S. Application Data
(60) Provisional application No. 61/648,157, filed on May 17, 2012.

(51) Int. Cl. F02B 39/16

(52) U.S. Cl. CPC F02B 39/16
USPC 403/66; 29/505

(57) ABSTRACT

A heat isolating actuator linkage (805, 905) that includes a rod end housing (810, 910) including a bearing opening (814, 914) with a rod end ball (812, 912) disposed therein. A race insert (816, 916) is disposed between the rod end housing (810, 910) and the rod end ball (812, 912). A threaded portion (818, 918) extends from the rod end housing (810, 910) and may comprise male or female threads. A shield (830, 930) extends from the rod end housing (810, 910). The shield (830, 930) is integrally formed with the rod end housing (810, 910). The shield (830, 930) extends around a majority of the rod end housing (810, 910) and may extend to one side of the bearing opening (814, 914). Alternatively, a first portion (932) of the shield may extend towards one side of the bearing opening (914) and a second portion (932) of the shield may extend towards the other side.

### BACKGROUND

Today's internal combustion engines must meet ever-stricter emissions and efficiency standards demanded by consumers and government regulatory agencies. Accordingly, automotive manufacturers and suppliers expend great effort and capital in researching and developing technology to improve the operation of the internal combustion engine. Turbochargers are one area of engine development that is of particular interest.

A turbocharger uses exhaust gas energy, which would normally be wasted, to drive a turbine. The turbine is mounted to a shaft that in turn drives a compressor. The turbine converts the heat and kinetic energy of the exhaust into rotational power that drives the compressor. The objective of a turbocharger is to improve the engine's volumetric efficiency by increasing the density of the air entering the engine. The compressor draws in ambient air and compresses it into the intake manifold and ultimately the cylinders. Thus, a greater mass of air enters the cylinders on each intake stroke.

Given that a turbocharger must handle exhaust straight from the engine, it can be appreciated that the components of a turbocharger are subjected to extreme temperatures. Many turbocharger components have been designed to handle extreme heat, particularly on the turbine side of the turbocharger. However, some components are difficult to make temperature resistant while maintaining functionality, such as the moving joints and actuators associated with variable turbine geometry (VTG) mechanisms and waste gate control mechanisms. Accordingly, these components must be at least partially protected from the heat generated by the exhaust gas.

### SUMMARY

Provided herein is a heat isolating actuator linkage that includes a rod end housing including a bearing opening with a rod end ball disposed therein. A race insert is disposed between the rod end housing and the rod end ball. A threaded portion extends from the rod end housing and may comprise male or female threads. A shield extends from the rod end housing.

In certain aspects of the technology described herein, the shield is integrally formed with the rod end housing. The shield extends around a majority of the rod end housing and extends to one side of the bearing opening. In another case, a first portion of the shield extends towards a first side of the bearing opening and a second portion of the shield extends towards a second side of the bearing opening.

Also contemplated herein are methods of constructing a heat isolating actuator linkage. In an embodiment, the method comprises forming a rod end housing, wherein the rod end housing includes a flange extending around a majority of the ball end portion. A rod end ball is inserted into the rod end housing and the flange is deformed toward one side of the ball end housing. The method may also include inserting a race insert between the rod end housing and the rod end ball, wherein the race insert is inserted prior to deforming the flange toward one side of the ball end housing. The step of deforming the rod end housing may comprise stamping or swaging, for example.

In another embodiment, the method may include forming a rod end housing, wherein the rod end housing includes a plurality of circumferentially spaced flange segments extending around the ball end portion. A rod end ball is inserted into the rod end housing and at least one flange segment is deformed toward a first side of the ball end housing and at least one flange segment is deformed toward a second side of the ball end housing, wherein the flange segments form a cage. The method may further comprise positioning a cover, in the form of a cup or disc, adjacent the rod end housing. The cover may be placed adjacent the rod end housing prior to deforming the flange segments to form the cage.

These and other aspects of the heat isolating linkages will be apparent after consideration of the Detailed Description and Figures herein. It is to be understood, however, that the scope of the invention shall be determined by the claims as issued and not by whether given subject matter addresses any or all issues noted in the background or includes any features or aspects recited in this summary.

### DRAWINGS

Non-limiting and non-exhaustive embodiments of the heat isolating linkage, including the preferred embodiment, are described with reference to the following figures, wherein like reference numerals refer to like parts throughout the various views unless otherwise specified.

FIG. 1 is a top plan view of a heat isolating linkage according to a first exemplary embodiment;

FIG. 2 is a top plan view of a heat isolating linkage according to a second exemplary embodiment;

FIG. 3 is a top plan view of a heat isolating linkage according to a third exemplary embodiment;

FIG. 4 is a top plan view of a heat isolating linkage according to a fourth exemplary embodiment;

FIG. 5 is a top plan view of a heat isolating linkage according to a fifth exemplary embodiment;

FIG. 6 is a top plan view of a heat isolating linkage according to a sixth exemplary embodiment;

FIG. 7 is a top plan view of a heat isolating linkage according to a seventh exemplary embodiment;

FIG. 8 is a front view in elevation of a conventional rod end;

FIG. 9 is a side view in elevation of the conventional rod end shown in FIG. 8;

FIG. 10 is a top plan view of a rod end heat isolating actuator linkage according to a first exemplary embodiment;

FIG. 11 is a side view in elevation of the rod end heat isolating actuator linkage shown in FIG. 10;

FIG. 12 is a top plan view of a rod end heat isolating actuator linkage according to a second exemplary embodiment;

FIG. 13 is a front view in elevation of the rod end heat isolating actuator linkage shown in FIG. 12; and

FIG. 14 is a partial cross-sectional view of the rod end housing shown in FIG. 13.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

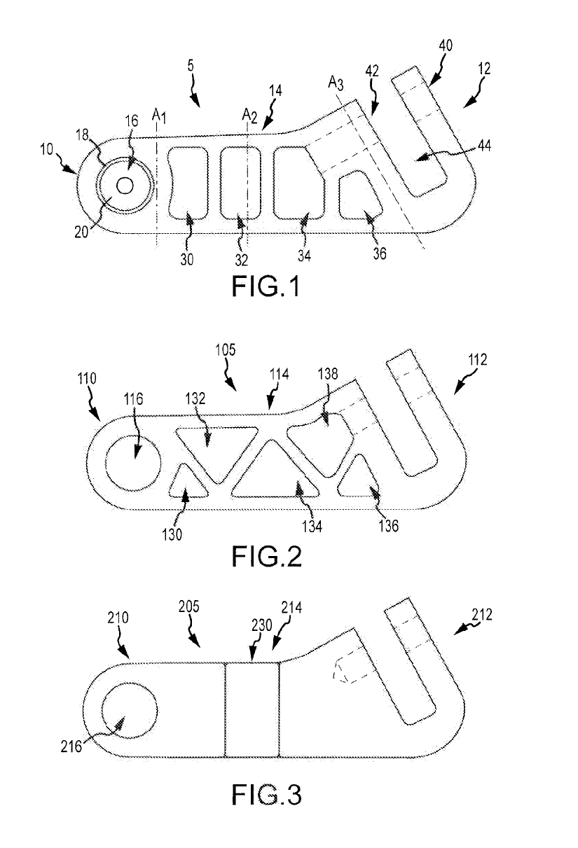

The heat isolating linkage 5 shown in FIG. 1 is for use with a VTG turbocharger. In this embodiment, the heat isolating linkage 5 includes a first end portion 10 and a second end portion 12 with a middle portion 14 extending therebetween. The first end portion 10 includes a bearing opening 16 sized and configured to receive a bearing race 18 and a rod end ball 20. The second end portion 12 is, in this case, in the form of an actuator shaft clamp 44 which includes a clearance hole 40 and a threaded aperture 42, both of which are configured to receive a fastener therein. The middle portion 14 of heat isolating linkage 5 includes a plurality of apertures 30-36. In this case, apertures 30-36 are rectangular in form and, also in this case, create a ladder pattern. It should be appreciated that while each of the apertures may be truncated with respect to neighboring features of the linkage, in general, the apertures are rectangular in form, such as aperture 32. For example, aperture 30 is contoured to match the bearing opening 16. As another example, aperture 36 is truncated such that it does not intersect the threaded aperture 42 or clamp region 44.

Apertures 30-36 have the effect of reducing the cross-sectional area of the mid-portion 14. For example, aperture 32 reduces the area A2 of the mid-portion such that it is less than the area of the first end portion cross-section or the second end portion cross-section A1 and A3, respectively. Therefore, heat transfer from the VTG mechanism is inhibited such that it protects the bearing race 18 from excessive heat.

A heat isolating linkage 105 according to a second exemplary embodiment is represented in FIG. 2. In this case, the linkage includes an elongate link having a first end portion 110 and a second end portion 112 with middle portion 114 extending therebetween. First end portion 110 includes bearing opening 116 and a plurality of apertures 130-138. As can be appreciated, the linkage 105 is similar to that described above with respect to FIG. 1; however, in this case, the apertures 130-138 are each in the form of a triangle which, in turn, creates a truss pattern. While the above described embodiments illustrate apertures with particular shapes, it should be understood that the shape of the cutouts should not be limited to rectangular or triangular, but can be any shape that reduces longitudinal cross-sectional area.

A heat isolating linkage 205 according to a third exemplary embodiment is shown in FIG. 3. Again, this linkage 205 has similar features to those described above with respect to FIGS. 1 and 2 in that linkage 205 includes an elongate link having a first end portion 210, a second end portion 212, and a middle portion 214 extending therebetween. In this case, however, the middle portion includes an insulation segment 230. Insulation segment 230 may be comprised of plastic or a composite plastic material having good heat isolation characteristics.

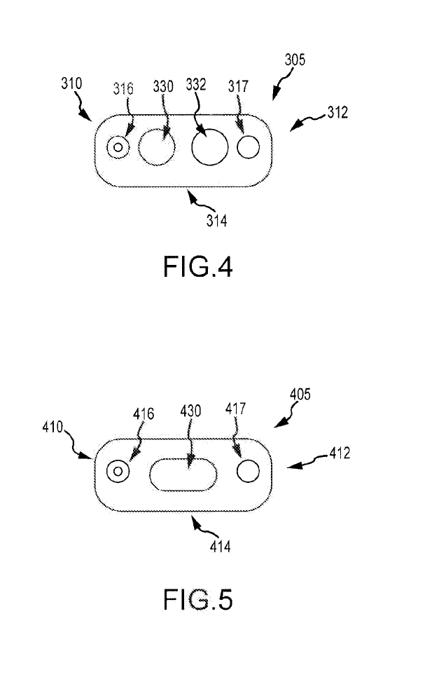

FIGS. 4-7 illustrate heat isolating linkages intended for use with waste gate actuators. For example, FIG. 4 is an elongate heat isolating linkage according to a fourth exemplary embodiment including a first end portion 310 and a second end portion 312 with a middle portion 314 extending therebetween. First end portion 310 includes a bearing opening 316 and second end portion 312 may include an aperture 317 to facilitate welding the lever to a waste gate shaft. Middle portion 314 includes apertures 330 and 332, which reduce the cross-sectional area of linkage 305, thereby reducing its heat conductivity. In this case, the apertures are in the form of circles; however, other aperture shapes may be used. For example, with reference to FIG. 5, heat isolating linkage 405 according to a fifth exemplary embodiment includes an elongate or obround aperture 430 formed through the mid-portion 414. Again, the linkage 405 includes first and second end portions 410 and 412, respectively, with middle portion 414 extending therebetween. First end portion 410 includes a bearing opening 416 and second end portion 412 may include an aperture 417.

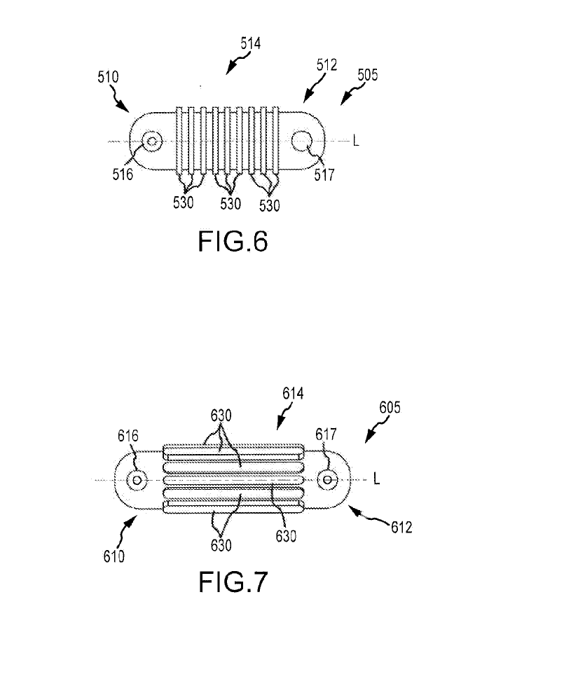

Waste gate heat isolation linkage 505 according to a sixth exemplary embodiment is shown in FIG. 6. Linkage 505 includes first and second end portions 510 and 512, respectively, with a middle portion 514 extending therebetween. First end portion 510 includes a bearing opening 516 and second end portion 512 may include an aperture 517. In this case, middle portion 514 includes a plurality of cooling elements, such as cooling fins 530. Linkage 505 extends along a longitudinal axis L. As can be seen in the figure, the cooling fins 530 extend transversely, or orthogonally, to the longitudinal axis L. FIG. 7 illustrates linkage 605 according to a seventh exemplary embodiment, which also includes cooling fins. Linkage 605 includes first and second end portions 610 and 612, respectively, with middle portion 614 extending therebetween. First end portion 610 includes a bearing opening 616 and second end portion 612 may include an aperture 617. Middle portion 614 includes a plurality of longitudinally extending cooling fins 630. As can be appreciated with reference to the figure, cooling fins 630 extend longitudinally along the longitudinal axis L of linkage 605. Although the cooling elements above are illustrated as fins having particular orientations, it should be appreciated that the cooling elements may have different forms and orientations, such as for example, rods that could be spiral as well as longitudinal, or orthogonal, or other suitable geometry.

Also disclosed herein is a heat isolating actuator linkage in the form of a rod end. As shown in FIGS. 8 and 9, a conventional rod end 705 includes a rod end housing 710 with a bearing opening 714 formed therethrough. Inserted into the bearing opening 714 is a race insert 716. Race insert 716 may be comprised of a bearing material such as bronze or plastic, for example. A rod end ball 712 is disposed in the race insert. Accordingly, the race insert acts to prevent metal-to-metal contact between the rod end ball and the rod end housing 710. The bearing housing also includes a threaded portion 718 extending from the rod end housing. In this case, the threaded portion includes female threads. However, as is known in the art, the rod end threaded portion may include male threads. It should be appreciated that with a conventional rod end bearing, the race insert and rod end ball are exposed to heat in the surrounding environment on both sides of the rod end.

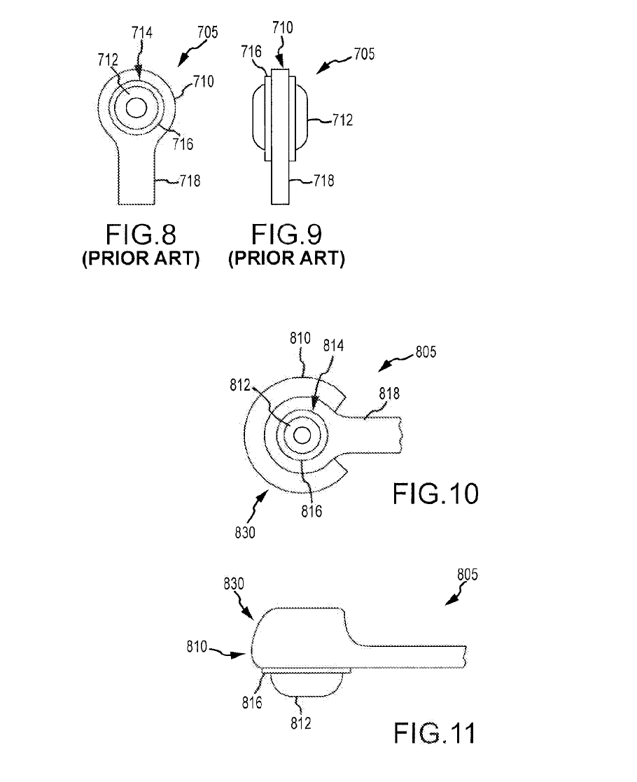

FIG. 10 illustrates a heat isolating actuator linkage in the form of a rod end according to a first exemplary embodiment. In this embodiment, rod end 805 includes a housing 810 with a rod end ball 812 and race insert 816 disposed therein. In FIG. 10, it can be seen that housing 810 also includes a shield flange 830 in a pre-formed or pre-stamped state. With further reference to FIG. 11, which shows the shield 830 in its final form after stamping, it can be appreciated that the shield 830 extends to one side of the rod end housing 810. Accordingly, the shielded side of the rod end 805 is placed adjacent the heat source such as the turbine housing of a turbocharger. Accordingly, the heat shield 830 prevents the transfer of heat to the race insert which may be damaged by excessive heat emanating from the turbine housing.

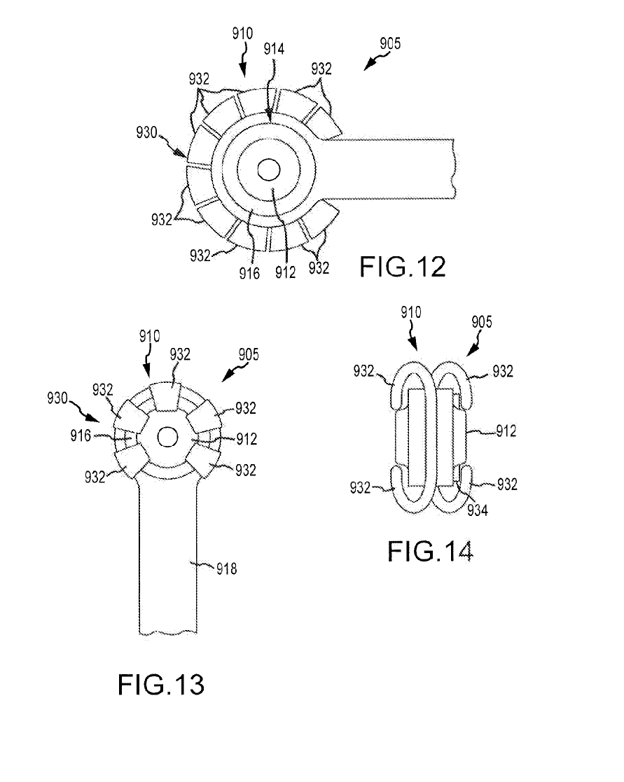

FIG. 12 illustrates a rod end heat isolating actuator linkage according to a second exemplary embodiment. In this case, rod end 905 includes a rod end housing 910 with a race insert 916 and a rod end ball 912 assembled therein. In this case, shield 930 comprises a plurality of circumferentially spaced flange segments 932. As shown in FIG. 12, the flange segments are formed onto the rod end housing 910 and are thereafter stamped or otherwise deformed into position. With reference to FIGS. 13 and 14, it can be appreciated that every other flange segment 932 is bent to one side or the other of the rod end housing 910, thereby creating a cage-like structure on both sides of the race insert. As shown in FIG. 14, a cover 934 may be inserted between the flange segments 932 and the rod end housing 910. Cover 934 may be placed adjacent rod end housing 910 prior to bending flange segments 932 into position, thereby capturing cover 934 in place. Cover 934 may be in the form of a disc or cup shaped shield element, for example.

Accordingly, the heat isolating linkages have been described with some degree of particularity directed to the exemplary embodiments. It should be appreciated; however, that the present invention is defined by the following claims construed in light of the prior art so that modifications or changes may be made to the exemplary embodiments without departing from the inventive concepts contained herein.

What is claimed is:

1. A heat isolating actuator linkage (805, 905), comprising:
a rod end housing (810, 910) including a bearing opening (814, 914) formed therethrough;
a shield (830, 930) extending from the housing (810, 910); and
a rod end ball (812, 912) disposed in said bearing opening (814, 914).

2. The heat isolating actuator linkage (805, 905) according to claim 1, further comprising a race insert (816, 916) disposed between the rod end housing (810, 910) and the rod end ball (812, 912).

3. The heat isolating actuator linkage (805, 905) according to claim 1, further comprising a threaded portion (818, 918) extending from the rod end housing (810, 910).

4. The heat isolating actuator linkage (805, 905) according to claim 3, wherein the threaded portion (818, 918) comprises male threads.

5. The heat isolating actuator linkage (805, 905) according to claim 1, wherein the shield (830, 930) is integrally formed with the rod end housing (810, 910).

6. The heat isolating actuator linkage (805, 905) according to claim 1, wherein the shield (830, 930) extends around a majority of the rod end housing (810, 910).

7. The heat isolating actuator linkage (905) according to claim 1, wherein a first portion (932) of the shield (930) extends towards a first side of the bearing opening (914) and a second portion (932) of the shield (930) extends towards a second side of the bearing opening (914).

8. A method of constructing a heat isolating actuator linkage (805), the method comprising:
forming a rod end housing (810), wherein the rod end housing (810) includes a flange (830) extending around a majority of the rod end housing (810);
inserting a rod end ball (812) into the rod end housing (810); and
deforming the flange (830) toward one side of the rod end housing (810).

9. The method according to claim 8, further comprising inserting a race insert (816) between the rod end housing (810) and the rod end ball (812).

10. The method according to claim 9, wherein the race insert (816) is inserted prior to deforming the flange (830) toward one side of the rod end housing (810).

11. The method according to claim 8, wherein forming the rod end housing (810) comprises stamping.

12. A method of constructing a heat isolating actuator linkage (905), the method comprising:
forming a rod end housing (910), wherein the rod end housing (910) includes a plurality of circumferentially spaced flange segments (932) extending around the rod end housing (910);
inserting a rod end ball (912) into the rod end housing (910);
deforming at least one flange segment (932) toward a first side of the ball end housing (910); and
deforming at least one flange segment (932) toward a second side of the ball end housing (910).

13. The method according to claim 12, wherein the flange segments (932) form a cage.

14. The method according to claim 13, further comprising positioning a cover (934) adjacent the rod end housing (910).

15. The method according to claim 14, wherein the cover (934) is placed adjacent the rod end housing (910) prior to deforming the flange segments (932) to form the cage.
